(19) United States
(12) Patent Application Publication
(10) Pub. No.: US 2011/0178833 A1
(43) Pub. Date: Jul. 21, 2011

(54) DEVELOPING AN OPTIMAL LONG TERM ELECTRICITY GENERATION CAPACITY RESOURCE PLAN UNDER A CARBON DIOXIDE REGULATORY REGIME

(75) Inventors: Pawan R. Chowdhary, Yorktown Heights, NY (US); Anshul Gupta, Yorktown Heights, NY (US); Rahul Jain, Hawthorne, NY (US); Jayant Kalagnanam, Yorktown Heights, NY (US); Stuart Siegel, Yorktown Heights, NY (US); Dharmashankar Subramanian, Yorktown Heights, NY (US)

(73) Assignee: INTERNATIONAL BUSINESS MACHINES CORPORATION, Armonk, NY (US)

(21) Appl. No.: 12/690,573

(22) Filed: Jan. 20, 2010

(51) Int. Cl. G06Q 10/00; G06Q 50/00; G06F 1/26

(52) U.S. Cl. 705/7.12; 705/301; 705/317; 705/348; 700/291

(57) ABSTRACT

There are provided a method and system for optimizing of a long-term electricity resource plan. The system obtains a capital costs component value including capital costs for emission abatement retrofits at an existing power plant and a new power plant over a period of time. The system obtains a fuel costs component value including the sum of fuel utilization of all generating units in the existing power plant and new power plant over the period of time. The system obtains an emission costs component value including emission allowance costs and emission violation costs in the period of time. The system adds the capital costs component value, the fuel costs component value and the emission costs component value to compute a net present value that meets emission constraints.

### BACKGROUND

The present invention relates generally to the field of power generation and, more particularly, to a method and system for deriving an optimized power system design from a set of input parameters for minimizing the present value of variable and fixed cost while meeting carbon dioxide emission constraints.

The basic functions of a power system are to continuously maintain an adequate supply of electric power and to economically and reliably provide electric power to customers. Power system planners, designers, and operators are generally concerned with a reliability of their systems and a determination of realistic adequacy/availability targets for their systems. Recently, this concern has been accentuated by a prospect of new restrictions imposed on carbon dioxide emissions by environmental regulatory bodies. Increased pressure from regulatory bodies to keep carbon dioxide emissions and electric rates to a minimum has forced utility managers to look for more advanced analytical methods for determining the benefits and costs of system enhancements and still meet emission constraints.

Power systems typically are complex, highly integrated, and large. A power system model may be divided into appropriate subsystems that can be analyzed separately. For example, such subsystems may include generating stations, a generating subsystem, a transmission network, a distribution network, a bulk generation and transmission subsystem, and interconnected systems, substations, and protection systems.

Primary reliability indices for distribution networks include, but not limited to: an average failure rate, average outage duration, average annual reliability, and average annual outage time. These indices are indicative of reliability levels of the power system but do not provide a complete representation of system behavior. Additional indices must be computed to assess a system. These additional indices may include load and energy indices which are useful in predicting future reliability and in assessing past performance of the system.

A power system is a combination of generation facilities and a transmission network. A survey indicated that various areas that should be considered when evaluating power system should include, among other parameters, an optimization of investment.

The selection of design criteria for new or additional equipment can be based on an overall system optimization. For example, the selection of design criteria should consider reliability, cost, revenue, benefit to and effect on power supply if the additional facility or emission control measures are implemented, and system integrity with or without these modifications while meeting emission constraints.

Current solution methodologies typically comprise simplified scenario analysis for a small number of combinations which represent various predictions of the future. The problem with this approach is that the solutions obtained may not be robust to the full range of uncertainties that are inherent in the problem.

Currently no individualized method or tool exists which integrates carbon dioxide abatement strategies into long term capacity resource plans. Additionally, there are no well-adopted methodological frameworks for making optimal capacity planning and abatement decisions that explicitly model uncertainties such as regulatory rules, technology cost and performance.

A need exists for an advanced analytical tool that can be used to complement the planning process used today so that a more complete analysis of system alternatives can be made.

### SUMMARY

Accordingly, a primary goal of the present invention is to provide an analytical tool that will enhance the power system planning and operation processes. This tool should consider equipment and costs for a complete assessment of system alternatives.

A further goal of the present invention is to provide practical embodiments of such a tool, wherein the embodiments allow the user to: (1) evaluate planning alternatives and make it easier for utilities to justify or delay projects within a more complete framework than the one used today; (2) model and assess different operational practices; and (3) optimize designs from a cost/benefit perspective.

One embodiment of the invention provides a method for assessing the cost of power generation over a defined period of time. Cost assessment of a power system is concerned with a determination of adequacy levels of the combined generation and transmission facilities in regard to providing a dependable and suitable supply at the consumer end of the system. Based upon this assessment, cost targets may be established to guide the development of new arrangements and utilization of planned and existing generating capacity. By targeting costs, optimum layouts and design concepts can be developed with due consideration given to benefits and constraints of equipment technologies and costs.

The invention combines economics with probabilistic techniques in the analysis of planning and operating alternatives. It includes sophisticated programming techniques for minimizing the net present value of variable and fixed costs of an electric utility while meeting emissions constraints for a period of time. The invention not only assesses both variable and fixed costs, but also assesses the impact of specific layouts on the power system. The invention makes use of accurate and computationally fast techniques permitting its use on different hardware platforms.

In an embodiment there is provided a method for optimizing of a long-term electricity resource plan, the method comprising;

receiving a first data for calculating a capital costs component value, the first data including capital costs for emission abatement retrofits at an existing power plant and a new power plant over a period of time;

receiving a second data for calculating a fuel costs component value, the second data including a sum of fuel utilization of all generating units in the existing power plant and new power plant over the period of time;

receiving a third data for calculating an emission costs component value, the third data including emission allowance costs and emission violation costs in the period of time; and

adding the capital costs component value, the fuel costs component value and the emission costs component value to compute a resulting value that meets emission constraints,

wherein a program using a processor unit runs one or more of: the receiving the first data, the receiving the second data, receiving the third data and the adding.

In another embodiment there is provided a computer-implemented system for optimizing of a long-term electricity resource plan, the system comprising:

a memory device; and

a processor unit in communication with the memory device, the processor unit performing steps of:

receiving first data calculating a capital costs component value, the first data including capital costs for emission abatement retrofits at an existing power plant and a new power plant over a period of time;

receiving first data calculating a fuel costs component value, the second data including a sum of fuel utilization of all generating units in the existing power plant and new power plant over the period of time;

receiving a third data calculating an emission costs component value, the third data including emission allowance costs and emission violation costs in the period of time; and

adding the capital costs component value, the fuel costs component value and the emission costs component value to compute a resulting value that meets emission constraints.

In a further embodiment, the processor unit further performs:

providing boundary conditions to one or more of: the capital costs component value, the fuel costs component value and the emission costs component value.

### BRIEF DESCRIPTION OF THE DRAWINGS

Other aspects, features, and advantages of the present invention will become more fully apparent from the following detailed description, the appended claims, and the accompanying drawings in which similar elements are given similar reference numerals.

FIG. 1 provides an overview of the present invention by depicting a programmed computer workstation and inputs and output of a programmed analysis.

FIG. 2 is a flow chart of a substation optimization procedure in accordance with the present invention.

FIG. 3 is an exemplary hardware configuration running or implementing the flow chart depicted in FIG. 2 in according to one embodiment of the present invention.

### DETAILED DESCRIPTION OF PREFERRED EMBODIMENTS

The present invention is preferably embodied as a method for the optimization of an electricity resource plan with consideration of a cap (e.g., a maximum limit) on the amount of carbon dioxide that can be emitted to the atmosphere. One embodiment of the present invention reflects a growing public concern over emissions of carbon dioxide and in particular emissions from fossil-fuel fired power plants. The method can be used to determine an effect on both existing generation capacity (via a need to install emission control equipment) and on the addition of new capacity to meet future increased demand. According to one embodiment of the invention, each utility using the present invention is modeled analytically. The method includes minimizing a net present value (NPV) of variable, fixed and capital costs over a planning horizon while meeting carbon dioxide emissions limits imposed by a cap-and-trade scheme. The net present value is a way to compare a present value of money to a future value of the money. For example, a dollar today may be worth more than a dollar in the future due to potential inflation in the future.

A power plant or power station includes at least one (electricity) generating unit. The generating unit may generate the electricity by using one or more of: petroleum, nuclear material, coal, gas, or fuel.

Several practical applications of the present invention include an optimal determination of the least cost generation, a capacity investment strategy for meeting demand and emission limits, and an optimal mix of emission retrofitting vs. new capital investment.

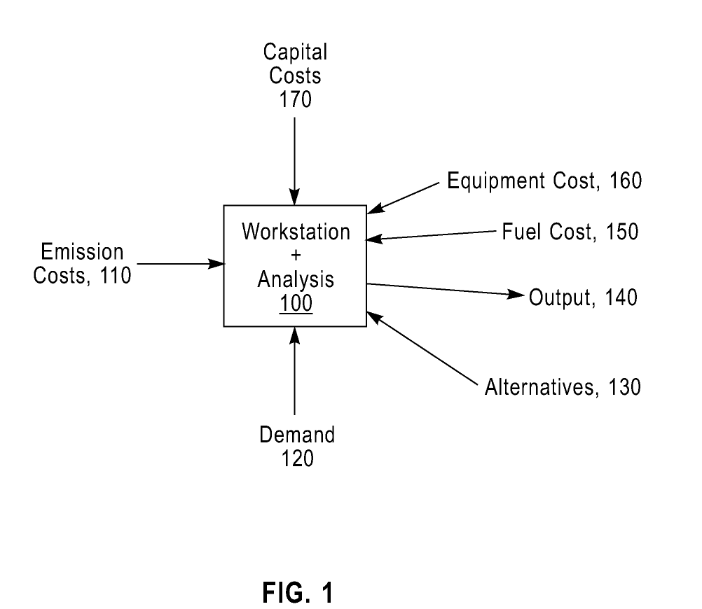

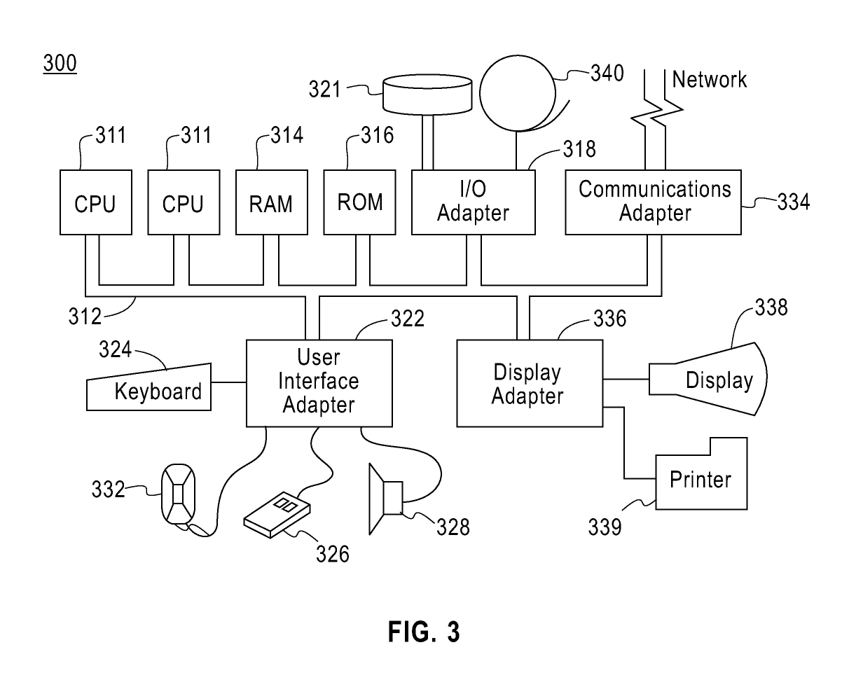

FIG. 1 is a schematic overview of the present invention. The invention employs a programmed computer workstation and a probabilistic-based methodology, as opposed to the deterministic-based methodologies currently employed by electric utilities. Deterministic-based methodologies consider only the effect of different pre-selected contingencies on the system without considering the likelihood of occurrences of those contingencies. In contrast, the probabilistic-based methodology considers likelihood of occurrences of the contingencies. As indicated in FIG. 1, a computing system (e.g., a computing system 300 in FIG. 3) determines an optimal alternative 140 (i.e., a minimized net present value) by analyzing 100 capital costs 170, fuel costs 150, emission costs 110, equipment costs 160, demand 120, aggregate demand alternatives 130 (e.g., alternative energies), etc.

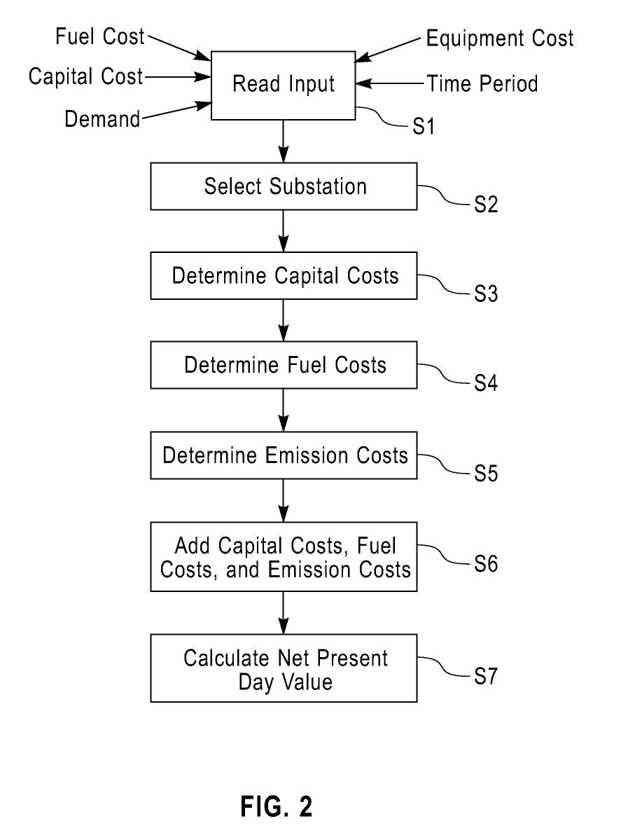

FIG. 2 is a flow chart of a resource planning optimization procedure in accordance with one embodiment of the present invention. The method described in FIG. 2 allows for an integrated consideration of uncertainty via a specification of continuous probability distribution for any number of uncertain inputs and allows planners to specify risk tolerance measures used to generate robust (with respect to the specified uncertainties) optimal solutions. Currently no individualized method or tool exists to integrate carbon dioxide abatement strategies into long-term capacity resource plans.

At step S1 in FIG. 2, the computing system 300 receives inputs including, but not limited to: an optimization objective including CO2 generation, a list of emission abatement retrofit equipment available for an existing generator, fuel cost, capital cost, projected demand, a time period, costs for equipment, etc. As indicated in the flow chart, the optimization objective can be in terms of minimum cost while meeting CO₂ constraints. At step S2, the computing system 300 selects an optimal mix of fuel choice and capital expenditures (which could include adding CO₂ abatement equipment, investing in thermal efficiency enhancements and/or investing in new power plants. At step S3, the computing system 300 determines capital cost of the at least one power plant, e.g., by calculating a Capital Costs component value described below. At step S4, the computing system 300 determines fuel cost of the at least one power plant, e.g., by calculating a Fuel Costs component value described below. At step S5, the computing system 300 determines emissions cost of the at least one power plant, e.g., by calculating a Emission Costs component value described below. At step S6, the computing system 300 uses these inputs (e.g., capital cost, fuel cost, emission cost, etc.) to formulate and solve a mixed integer optimization model (i.e., a minimum net present value=the Capital Costs component+Fuel Costs component+the Emission Costs component) that determines the least cost means of meeting all generation and emission constraints on the system.

Objective Function

According to one embodiment of the present invention, the computing system 300 optimizes a long-term electricity resource plan with a consideration of a cap and trade regulatory requirement, e.g., by minimizing the net present value of all variables and fixed costs during the planning while meeting emission constrains. The minimum net present value is calculated in accordance with an equation (1) as follows:

minNPV=Capital Costs component+Fuel Costs component+Emission Costs component. (1)

A decision pertaining to capital expenditure are restricted to a planning horizon (i.e., a period of the resource planning), namely, a set {1, . . . , T}, where T is the number of time periods in the planning horizon over which capital expenditure decisions are made. Overall economic and operational consequences of such decisions are modeled over an extended horizon, namely, a set {1, . . . , T+Tₚ}, where Tₚ is payment horizon (i.e., a period of payment) for recurring payment that is incurred on capital expenditure. The computing system also accommodates the economic and operational consequences of a limiting case where capital expenditure decisions are taken in the last planning period, T. The function (1) is a sum over all costs for all periods with appropriate time value of money discounting applied to put a value in net present value terms.

The Capital Costs component value, represented in dollars, is given by a sum of leveraged and recurring capital cost for emission abatement retrofits (e.g., new equipment installed for reducing emissions) at existing plants and new plants, if any, discounted over time. In each period of the resource planning (typically a year), there will be costs (e.g., capital cost, fuel cost, emission cost, etc.). The computing system 300 discounts (i.e., deducts a certain amount from) a future cost to reflect a fact that a dollar in the future is not worth the same thing as a dollar today. A discount rate reflects how much a user (e.g., a company providing electricity resource) pay for borrowing money, how much a user earn on user's own money, and how much a user expect inflation to be. The computing system discounts future cash flows to reflect that they are not as valuable as having them today.

The Fuel Costs component value, represented in dollars, is given by a sum of fuel utilization at all existing and new, if any, generating units, discounted over time.

The Emission Costs component value, represented in dollars, is given by a sum of emission allowance cost (i.e., cost spent to obtain an authorization to emit a fixed amount of pollutant) and emission violation cost (i.e., cost spent to pay a violation of an emission limit), if any, discounted over time. The Emission Costs component value includes purchasing cost associated with purchase of emission allowances and penalty that is incurred if in violation of an emission regulatory limit.

Formulation

Various terms and definitions of the terms used in the functions for the Capital Costs component value, the Fuel Costs component value, and the Emission Costs component value are as follows:

Indices:
i=an existing generating unit operated by a utility
j=an available new plant investment option (e.g., brining a new plant on line to meet demand and/or because the new plant uses a cleaner technology)
f=an available fuel choice, e.g., gas, coal, nuclear material, etc.
t=a time period (t=0, 1, 2, . . . ). The time index 0 is introduced for convenience, and it represents an initial condition.
r=an available emission abatement retrofit (for existing u) option

Parameters:

αε(0,1), time discount factor (In a future period, a dollar is worth less than it is today.

The amount that a user discounts a future dollar depends on at least one factor. The at least one factor may change over time (based on user's expectation about cost of money or inflation).

T=number of time periods in the planning horizon over which capital expenditure decisions may be made.

Tₚ=payment horizon for the recurring payment that is incurred on capital expenditure. The computing system 300 models the capital expenditure as a constant-level and recurring set of payments over a payment horizon. The payment horizon extends from a point of purchase, for example, t to t+Tₚ.

N_{E}, N_{R}, N_{N}, N_{F}=number of existing units, retrofit options, new units, fuel types.

δ_{if}^{e}=Boolean (1 or 0) parameter that captures whether fuel f may be used on existing unit i or not, for any i and f.

δ_{jf}ⁿ=Boolean (1 or 0) parameter that captures whether fuel f may be used on new unit/or not, for any j and f.

F={1, . . . , N_{F}}. This is an index set of all available fuel types.

Fᵢ={fεF|δ_{if}^{e}=1}. This is a subset of fuel type indices that may be used with existing unit i, for any i.

Fᵢ={fεF|δ_{jf}ⁿ=1}. This is a subset of fuel type indices that may be used with new unit j, for any j.

Kᵢᵣₜ^{e}=a per-period, recurring (over a payment horizon) cost (e.g., fixed debt, mortgage payment) of abatement investment option r for unit i, if an investment decision is made at the start of time period t, for any i, r, tε{1, . . . , T}. This is a constant-level, recurring cost over a payment horizon that starts from the time index, t, and continues till t+Tₚ. It is a function of time because the cost of a technology may vary, depending on when it is actually commissioned.

Kⱼₜⁿ=this is same as Kᵢᵣₜ^{e} except for new generation unit j.

Pₜ=an emission allowance purchase price at the start of time period t, for any tε{1, . . . , T+Tₚ} ($/lb)

Vₜ=Violation penalty rate on excess emissions (in lb equivalents) relative to a regulatory emission limit ($/lb), for any tε{1, . . . , T+Tₚ}. A regulatory emission limit can be, for example, a requirement placed on a utility company by a regulatory body (e.g., a local, state, or federal environment protection agency) that emissions of CO₂ in a given year cannot exceed “X” tons, where X is presumably some value lower than the emissions would be if the utility company was not regulated in such a manner.

Cᵢₜ^{e}=Total energy generation capacity (MWH) of existing unit i over time period t, for any i, tε{1, . . . , T+Tₚ}. A time-dependent nature of this parameter may be used to capture capital decommissioning or sun-setting of the unit. MWH stands for “Megawatt-hour”, a unit of total energy. MW is “Megawatt” which is a unit of power.

Cⱼₜⁿ=Total energy generation capacity (MWH) of new unit j over time period t, for any i, tε{1, . . . , T+Tₚ}. A time-dependent nature of this parameter may be used to capture capital decommissioning or sun-setting of the unit.

$${C}_{ift}^{e} = a delivered cost of fuel f at unit i in period t ( \frac{\$}{MBTU} ) ,$$

for any i, fεFᵢ, tε{1, . . . , T+Tₚ}. MBTU refers to Millions of British Thermal Units.

$${C}_{jft}^{n} = a delivered cost of fuel f at unit j in period t ( \frac{\$}{MBTU} ) ,$$

for any j, fεFⱼ, tε{1, . . . , T+Tₚ}.

$${h}_{if}^{e} = heat rate ( a measure of efficiency ) of unit i utilizing fuel f in period t ( \frac{MBTU}{MWH} ) ,$$

for any i, fεFᵢ. The heat rate of a power plant is a measure of how efficiently the plant converts the energy contained in the fuel fed to it into electricity. For example, coal fired power plants waste about 70% on average of the energy in the fuel as heat (only 30% of the coal's energy ends up as electricity). The higher the heat rate, the lower the plant's efficiency.

$${h}_{jf}^{n} = heat rate of unit j utilizing fuel f in period t ( \frac{MBTU}{MWH} ) ,$$

for any j, fεFⱼ.

γ_{ifr}=heat rate parasitic factor (multiplier), due to parasitic load from the retrofit, r, at unit i, upon utilizing fuel f, for any i, r, fεFᵢ.

Dₜ=total projected energy demand in period t, for tε{1, . . . , T+Tₚ} (MWH).

Eₜ⁰=regulatory emission limit for time period, t, tε{1, . . . , T±Tₚ}.

ε_{if}^{e}=emission per unit fuel input at existing unit i with fuel f (lb/MBTU), for any i, fεFᵢ.

ε_{jf}ⁿ=emission per unit fuel input at new unit j with fuel f (lb/MBTU), for any j, fεFⱼ.

ηᵢᵣ=emission abatement efficiency of retrofit option r at unit i, for any i, r.

Variables:

wᵢᵣₜ=binary (0 or 1) decision variable representing a presence of a generating unit i retrofitted with an emission abatement device r in period t, for any i, r, tε{0, . . . , T+Tₚ}.

zⱼₜ=binary (0 or 1) decision variable representing a presence of a new generating facility j in period t, for any j, tε{0, . . . , T+Tₚ}

X_{ift}^{r}=an energy input of fuel f at unit i after retrofit r in period t (MBTU) (e.g., r=0 means without retrofit), for any i, fεFᵢ, tε{1, . . . , T+Tₚ}. Every fuel contains an inherent amount of theoretical energy that can be released by combusting it. This inherent amount of theoretical energy is called the energy input. This energy input is measured in “MBTU” and it depends on a chemical composition of the fuel. For example, coal contains about 10,000 MBTU per lb, oil about 14,000 etc.

y_{ift}=an energy input of fuel f at unit j after retrofit r in period t (MBTU), for any j, fεFⱼ, tε{1, . . . , T+Tₚ}.

eₜ=net emissions produced in period t (lb) that are in excess of the regulatory emission limit, for tε{1, . . . , T+Tₚ}. This variable captures the net (excess) amount of emissions from time period t that are in violation of the regulatory limit for time period t.

aₜ=the amount of emission allowance (in lb equivalents) that are purchased at the start of period t. This variable is a decision variable, for tε{1, . . . , T+Tₚ}. In one embodiment, the decision variable is something the computing system 300 is trying to find an optimal value for. For example, if the computing system 300 was trying to figure out how to allocation user's investments between stocks and bonds, the decision variables would be f_stocks and f_bonds, where f_stocks and f_bonds are fractions allocated to stocks and bonds respectively. It is a goal of the optimization model (i.e., function (1)) to find values of decision variable(s) while meeting constraints (e.g., f_stocks+f_bonds=1.0; f_stocks<100−user's age, etc.). In one embodiment, a decision variable represents one or more of, without limitation: how many emission allowances should be consumed in a given year, how much emission abatement equipment should be bought, or how much lower-emission fuel should be used, etc.

bₜ=the amount of emission allowance (in lb equivalents) that are applied towards reducing at net emissions at the end of period t. This variable is a decision variable, for tε{1, . . . , T+Tₚ}.

Capital Costs Component

The Capital Costs component value includes a multiplication of the per-period recurring cost of an abatement investment option for the existing unit, kᵢᵣₜ^{e}, and the binary decision variable representing the presence of the generating unit retrofitted with the emission abatement device (e.g., Carbon Capture and Sequestration (CSS)—CO₂ is captured and can be stored in underground where it can be permanently isolated) in a period of time, wᵢᵣₜ. The Capital Costs component value further includes a multiplication of the per-period recurring cost of abatement investment option for the new generating unit, kⱼₜⁿ, and the binary decision variable representing a presence of a new generating unit in the period of time, zⱼₜ. The Capital Costs component value also includes the binary variable representing the time discount factor, α. The Capital Costs component value is given by the expression:

$$Capital\_Cost = {\sum }_{t = 1}^{T} {\sum }_{{t}^{′} = t}^{t + {T}_{p}} {α}^{{t}^{′}} ( {\sum }_{i = 1}^{{N}_{E}} {\sum }_{r = 1}^{{N}_{R}} {k}_{irt}^{e} ( {w}_{irt} - {w}_{ir , t - 1} ) + {\sum }_{j = 1}^{{N}_{N}} {k}_{jt}^{n} ( {z}_{jt} - {z}_{j , t - 1} ) )$$

The Capital Cost component value is a sum of capital expenditures in each future period multiplied by a binary (yes or no) decision period representing a choice of making a capital investment in that year. For example, if a something costs $100 ten years from now but a user decides not to build it, the capital cost to the user is 100*x (where x=0) so the cost is zero. x is 0 or 1, if x is a binary decision variable. In Capital Cost component value, wᵢᵣₜ represents a choice of adding an emission control device to a power plant (a capital expense). zⱼₜ represents a choice of building a new power plant as opposed to retrofitting an existing one with emission control equipment.

Fuel Costs Component

The Fuel Costs component value includes, but not limited to: the delivered cost of fuel used at an existing generating unit in the period of time, c_{ift}^{e}, the energy input of the fuel at the existing generating unit after retrofit in the period of time, x_{ift}^{r}, and the energy input of the fuel at a new generating unit in the period of time, y_{jft}. The Fuel Costs component value is given by the expression:

$$Fuel\_Cost = {\sum }_{t = 1}^{T + {T}_{p}} {α}^{t} ( {\sum }_{i = 1}^{{N}_{E}} {\sum }_{f ∈ {F}_{i}} {c}_{ift}^{e} ( {x}_{ift}^{0} + {\sum }_{r = 1}^{{N}_{R}} {x}_{ift}^{r} ) + {\sum }_{j = 1}^{{N}_{N}} {\sum }_{f ∈ {F}_{j}} {c}_{jft}^{n} {y}_{jft} )$$

Emissions Costs Component

The Emission Costs component value includes, but not limited to: the amount of emission allowance that are purchased at the start of the period of time, aₜ, and net emissions produced in the period of time that are in excess of a regulatory emission limit, eₜ. The Emission Costs component value is given by the expression:

$$Emissions\_Cost = {\sum }_{t = 1}^{T + {T}_{p}} {α}^{t} ( {a}_{t} \cdot {P}_{t} + {e}_{t} \cdot {V}_{t} )$$

The Capital Costs component value involves capital expenditure related decision variables corresponding to time period 0, which need appropriate initial conditions. The following initial conditions describe that there are no abatement retrofits from the set {1, . . . , N_{R}} that are already present at the start of the planning horizon. Likewise, there are no new units from the set {1, . . . , N_{N}} that are already present at the start of the planning horizon.

wᵢᵣ₀=0,∀i=1, . . . , N_{E},r=1, . . . , N_{R}

zⱼ₀=0,∀j=1, . . . , N_{N}.

Constraints

Initial Conditions for Capital Costs Component

The following constraints ensure that once a capital expenditure decision is made at the start of any given time period, a corresponding equipment continues to be present over all subsequent time periods. These constraints apply capital expenditure, abatement retrofits and/or new generation units.

wᵢᵣₜ−q_{ir,t-1}≧0,∀i,r,tε[1:T+Tₚ]

zⱼₜ−z_{j,t-1}≧0,∀j,tε[1:T+Tₚ].

A constraint set below ensures that a user invests in at most one abatement retrofit option for each existing unit.

$${\sum }_{r = 1}^{{N}_{R}} {w}_{irt} \leq 1 , ∀ i , t ∈ [ 1 : T + {t}_{p} ]$$

Boundary Conditions for Capital Costs Component

In one embodiment, decisions pertaining to capital expenditure are restricted to the planning horizon, e.g., the set {1, . . . , T}. This restriction is mathematically captured using the following set of constraints:

wᵢᵣₜ=w_{ir,T},∀tε[T+1: T+Tₚ]

zⱼₜ=z_{j,T},∀tε[T+1: T+Tₚ].

Constraints to Fuel Costs Component

A maximum power rating (MW) that is associated with each generating unit represents a capacity constraint in terms of a total energy that may be generated over any chosen time period. This maximum power rating implies an upper bound for an amount of fuel that may be input into each generating unit over any chosen time period.

$${x}_{ift}^{0} + ( {\sum }_{r = 1}^{{N}_{R}} {w}_{irt} ) {C}_{it}^{e} {h}_{if}^{e} \leq {C}_{it}^{e} {h}_{if}^{e} , ∀ i , f ∈ {F}_{i} , t ∈ [ 1 : T + {T}_{p} ]$$

$${x}_{ift}^{r} - {w}_{irt} {C}_{it}^{e} {h}_{if}^{e} {γ}_{ifr} \leq 0 , ∀ i , f ∈ {F}_{i} , r , t ∈ [ 1 : T + {T}_{p} ]$$

$${y}_{jft} - {z}_{jt} {C}_{jt}^{n} {h}_{jf}^{n} \leq 0 , ∀ j , f ∈ {F}_{j} , t ∈ [ 1 : T + {T}_{p} ] ,$$

Capacity Constraints

The function (1), Capital Costs component value and Fuel Costs component value cover external customer demand or management related retrofits. Such retrofits cover customer demand or response management using various options such as advanced metering infrastructure, customer subsidies for compact fluorescent lighting adoption, etc. The following constraints describes that a total energy (MWH) that may be generated from any unit (existing or new) over any single time period, e.g., by using any combination of allowable fuel-types needs to respect a physical capacity (i.e. power rating) of a generation unit.

$${\sum }_{f ∈ {F}_{i}}^{ } ( \frac{{x}_{ift}^{0}}{{h}_{if}^{e}} + {\sum }_{r = 1}^{{N}_{R}} \frac{{x}_{ift}^{r}}{{h}_{if}^{e} {γ}_{ifr}} ) \leq {C}_{it}^{e} , ∀ i , t ∈ [ 1 : T + {T}_{p} ] , \\ {\sum }_{f ∈ {F}_{i}}^{ } ( \frac{{y}_{jft}}{{h}_{jf}^{n}} ) \leq {C}_{jt}^{n} , ∀ j , t ∈ [ 1 : T + {T}_{p} ] .$$

Demand Constraints

In each period, the utility (i.e., electricity generated from new power plant and/or existing power plant) must meet projected demand:

$${\sum }_{i = 1}^{{N}_{E}} {\sum }_{f ∈ {F}_{i}} ( \frac{{x}_{ift}^{0}}{{h}_{if}^{e}} + {\sum }_{r = 1}^{{N}_{R}} \frac{{x}_{ift}^{r}}{{h}_{if}^{e} {γ}_{ifr}} ) + {\sum }_{j = 1}^{{N}_{N}} {\sum }_{f ∈ {F}_{i}} ( \frac{{y}_{jft}}{{h}_{jf}^{n}} ) \geq {D}_{t} , \\ ∀ t ∈ [ 1 : T + {T}_{p} ] .$$

Constraints to Emission Costs Component

Total emissions from fuel usage for generating energy (in lb equivalents), less than the amount of emission allowances that are applied towards reducing net emissions, gives us the net emission from the utility that needs to be compared against the regulatory limit. If the net emissions are less than, or equal to a regulatory emission limit, then there is no violation penalty. In such a case, the variable eₜ, which captures the amount of net (excess) emissions that are in violation of the regulatory limit, takes on a value of zero. Otherwise, if the net (excess) emissions violate the regulatory limit, then the variable eₜ captures exactly the amount of violation. The following constraint set compares the total emissions to the regulatory limit in a mathematical form.

$${\sum }_{i = 1}^{{N}_{E}} ( {\sum }_{f ∈ {F}_{i}} ( {x}_{ift}^{0} {ε}_{if}^{e} + {\sum }_{r = 1}^{ } {x}_{ift}^{r} {ε}_{if}^{e} {η}_{ir} ) ) + {\sum }_{j = 1}^{{N}_{N}} {\sum }_{f ∈ {F}_{i}} ( {y}_{jft} {ε}_{jf}^{n} ) - {b}_{t} - {e}_{t} \leq {E}_{t}^{0} , \\ ∀ t ∈ [ 1 : T + {T}_{p} ] .$$

A user may assume that emission allowances may be banked over an extended problem horizon, {1, . . . , T+Tₚ}, i.e. the user may carry a net inventory of emission allowances from one time period to a next time period. The following set of constraints captures this carrying or banking of the emission allowance inventory.

$${\sum }_{t = 1}^{T + {T}_{p}} {a}_{t} - {b}_{a} \geq 0 , ∀ t ∈ [ 1 : T + {T}_{p} ] \qquad ( 2 )$$

The function (2) allows penalty for violating emission constraints, allows buying of allowances, and allows banking the penalty or the bought allowances. Although the function (2) does not allow trading of allowances as a financial instrument, a user may trade emission allowances like financial instrument.

In one embodiment, the method steps in FIG. 2 are implemented in hardware or reconfigurable hardware, e.g., FPGA (Field Programmable Gate Array) or CPLD (Complex Programmable Logic Device), using a hardware description language (Verilog, VHDL, Handel-C, or System C). In another embodiment, the method steps in FIG. 3 is implemented in a semiconductor chip, e.g., ASIC (Application-Specific Integrated Circuit), using a semi-custom design methodology, i.e., designing a chip using standard cells and a hardware description language. Thus, the hardware, reconfigurable hardware or the semiconductor chip operates the method steps described in FIG. 3.

FIG. 3 illustrates an exemplary hardware configuration of a computing system 300 running and/or implementing the method steps in FIG. 2. The hardware configuration preferably has at least one processor or central processing unit (CPU) 311. The CPUs 311 are interconnected via a system bus 312 to a random access memory (RAM) 314, read-only memory (ROM) 316, input/output (I/O) adapter 318 (for connecting peripheral devices such as disk units 321 and tape drives 340 to the bus 312), user interface adapter 322 (for connecting a keyboard 324, mouse 326, speaker 328, microphone 332, and/or other user interface device to the bus 312), a communication adapter 334 for connecting the system 300 to a data processing network, the Internet, an Intranet, a local area network (LAN), etc., and a display adapter 336 for connecting the bus 312 to a display device 338 and/or printer 339 (e.g., a digital printer of the like).

Following describes an example to describe NPV according to one exemplary embodiment. Suppose that a new capital project for installing a new plant or a new emission control device on an existing plant will cost “K” dollars. A user (e.g., a planner of the installation) finances 90% (0.9K) of the cost (i.e., the user puts down 0.1K in cash) and will be making fixed payments (which depends on user's cost of capital) over, for example, 5 years. Further assume the following:

assume that a lender offers the user, for example, 0% financing.

assume that user's average rate of return (the rate the user could earn on investing money in things other than this plant or abatement device) is r (0<=r<=1).

assume that the installation may not be made for the 5 years in the future.

The computing system 300 calculates the NPV, e.g., by flattening all user's initial cash expenditure plus user's regular debt payments (the 0.9K the user borrowed) into a single period (the present time). The computing system 300 may compare alternatives that might have costs over different time horizons. In this exemplary embodiment, the NPV is:

$$NPV = ( \frac{K}{10} ) \times {( 1 + r )}^{- 5} + ( \frac{0.9 K}{5} ) \times {( 1 + r )}^{- 5} + ( \frac{0.9 K}{5} ) \times {( 1 + r )}^{- 6} + ( \frac{0.9 K}{5} ) \times {( 1 + r )}^{- 7} + ( \frac{0.9 K}{5} ) \times {( 1 + r )}^{- 8} + ( \frac{0.9 K}{5} ) \times {( 1 + r )}^{- 9} \qquad ( 2 )$$

The formula (2) for calculating NPV corresponds to the capital components. However, the formula (2) can be extended to include the fuel components and/or the emission components. The first term in the formula (2),

$$( \frac{K}{10} ) \times {( 1 + r )}^{- 5} ,$$

indicates the value of user's K/10 dollars that the user has to put up in five years in today's dollars. The first term is smaller than K/10 because if the user is getting a return of r on user's money the user only needs to put aside (invest) something less than K/10 to reach K/10 in 5 years time. The other terms are just annual regular payments on the money (0.9K) the user borrowed spread out over 5 years.

Although the embodiments of the present invention have been described in detail, it should be understood that various changes and substitutions can be made therein without departing from spirit and scope of the inventions as defined by the appended claims. Variations described for the present invention can be realized in any combination desirable for each particular application. Thus particular limitations, and/or embodiment enhancements described herein, which may have particular advantages to a particular application need not be used for all applications. Also, not all limitations need be implemented in methods, systems and/or apparatus including one or more concepts of the present invention.

The present invention can be realized in hardware, software, or a combination of hardware and software. A typical combination of hardware and software could be a general purpose computer system with a computer program that, when being loaded and run, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a function described above. The computer readable program code means in the computer program product comprising computer readable program code means for causing a computer to effect one or more functions of this invention. Furthermore, the present invention may be implemented as a program storage device readable by machine, tangibly embodying a program of instructions runnable by the machine to perform method steps for causing one or more functions of this invention.

The present invention may be implemented as a computer readable medium (e.g., a compact disc, a magnetic disk, a hard disk, an optical disk, solid state drive, digital versatile disc) embodying program computer instructions (e.g., C, C++, Java, Assembly languages, .Net, Binary code) run by a processor (e.g., Intel® Core™, IBM® PowerPC®) for causing a computer to perform method steps of this invention. The present invention may include a method of deploying a computer program product including a program of instructions in a computer readable medium for one or more functions of this invention, wherein, when the program of instructions is run by a processor, the compute program product performs the one or more of functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

What is claimed is:

1. A method for optimizing of a long-term electricity resource plan, the method comprising;
receiving a first data for calculating a capital costs component value, the first data including capital costs for emission abatement retrofits at an existing power plant and a new power plant over a period of time;
receiving a second data for calculating a fuel costs component value, the second data including a sum of fuel utilization of all generating units in the existing power plant and new power plant over the period of time;
receiving a third data for calculating an emission costs component value, the third data including emission allowance costs and emission violation costs in the period of time; and
adding the capital costs component value, the fuel costs component value and the emission costs component value to compute a resulting value that meets emission constraints,
wherein a program using a processor unit runs one or more of: the receiving the first data, the receiving the second data, receiving the third data and the adding.

2. The method according to claim 1, wherein said capital costs component value includes a multiplication of a per-period recurring cost of an abatement investment option for an existing generating unit and a binary decision variable representing a presence of the existing generating unit retrofitted with an emission abatement device in the period of time.

3. The method according to claim 1, wherein said capital costs component value includes a binary variable representing a time discount factor.

4. The method according to claim 1, wherein said capital costs component value includes a multiplication of a per-period recurring cost of an abatement investment option for a new generating unit and a binary decision variable representing a presence of a new generating unit in the period of time.

5. The method according to claim 1, wherein said fuel costs component value includes a delivered cost of fuel used at an existing generating unit in the period of time, energy input of the fuel at the existing generating unit after retrofit in the period of time, and energy input of the fuel at a new generating unit in the period of time.

6. The method according to claim 1, wherein the emission costs component value includes an amount of emission allowance that are purchased at a start of the period of time and net emissions produced in the period of time that are in excess of a regulatory emission limit.

7. The method according to claim 1 further comprises:
providing initial conditions for the capital costs component value, the initial conditions ensuring that once a capital expenditure decision is made at a start of the period of time, a corresponding equipment continues to be present over all subsequent periods of time.

8. The method according to claim 1 further comprises:
acquiring constraints to one or more of: the capital costs component value, the fuel costs component value and the emission costs component value.

9. The method according to claim 8, wherein the acquired constraints of the fuel costs component value includes a maximum power rating associated with each generating unit, the maximum power rating representing a total energy generated by each generating unit over the period of time and indicating an upper bound for an amount of fuel inputted into each generating unit over the period of time.

10. The method according to claim 8, wherein the acquired constraints further comprises: capacity constraints and demand constraints, the capacity constraints including a total energy generated from a generating unit over the period of time, the demand constraints including a projected demand over the period of time.

11. The method according to claim 8, wherein the acquired constraints of the emission costs component value includes one or more of: a comparison of total emissions from all the generating units to a regulatory emission limit, a purchase of emission allowance, a transfer of the emission allowance from the period of time to a next period of time.

12. A computer-implemented system for optimizing of a long-term electricity resource plan, the system comprising:
a memory device; and
a processor unit in communication with the memory device, the processor unit performing steps of:
receiving a first data for calculating a capital costs component value, the first data including capital costs for emission abatement retrofits at an existing power plant and a new power plant over a period of time;
receiving a second data for calculating a fuel costs component value, the second data including a sum of fuel utilization of all generating units in the existing power plant and new power plant over the period of time;
receiving a third data for calculating an emission costs component value, the third data including emission allowance costs and emission violation costs in the period of time; and
adding the capital costs component value, the fuel costs component value and the emission costs component value to compute a resulting value that meets emission constraints.

13. The system according to claim 12, wherein said capital costs component value includes a multiplication of a per-period recurring cost of an abatement investment option for an existing generating unit and a binary decision variable representing a presence of the existing generating unit retrofitted with an emission abatement device in the period of time.

14. The system according to claim 12, wherein said capital costs component value includes a binary variable representing a time discount factor.

15. The system according to claim 12, wherein said capital costs component value includes a multiplication of a per-period recurring cost of an abatement investment option for a new generating unit and a binary decision variable representing a presence of a new generating unit in the period of time.

16. The system according to claim 12, wherein said fuel costs component value includes a delivered cost of fuel used at an existing generating unit in the period of time, energy input of the fuel at the existing generating unit after retrofit in the period of time, and energy input of the fuel at a new generating unit in the period of time.

17. The system according to claim 12, wherein the emission costs component value includes an amount of emission allowance that are purchased at a start of the period of time and net emissions produced in the period of time that are in excess of a regulatory emission limit.

18. The system according to claim 12, wherein the processor unit further performs:
providing initial conditions for the capital costs component value, the initial conditions ensuring that once a capital expenditure decision is made at a start of the period of time, a corresponding equipment continues to be present over all subsequent periods of time.

19. The method according to claim 12, wherein the processor unit further performs:
acquiring constraints to one or more of: the capital costs component value, the fuel costs component value and the emission costs component value.

20. The system according to claim 19, wherein the acquired constraints of the fuel costs component value includes a maximum power rating associated with each generating unit, the maximum power rating representing a total energy generated by each generating unit over the period of time and indicating an upper bound for an amount of fuel inputted into each generating unit over the period of time.

21. The system according to claim 19, wherein the acquired constraints further comprises: capacity constraints and demand constraints, the capacity constraints including a total energy generated from a generating unit over the period of time, the demand constraints including a projected demand over the period of time.

22. The system according to claim 19, wherein the acquired constraints of the emission costs component value includes one or more of: a comparison of total emissions from all the generating units to a regulatory emission limit, a purchase of emission allowance, a transfer of the emission allowance from the period of time to a next period of time.

23. A computer readable medium embodying computer program instructions being run by a processor for causing a computer to perform method steps for optimizing of a long-term electricity resource plan, said method steps comprising the steps of claim 1.

24. A method of deploying a computer program product including programs of instructions in a computer readable medium for optimizing of a long-term electricity resource plan, wherein, when the programs of instructions are run by at least one processor, the computer program product performs the steps of claim 1.
